(19) United States
(12) Patent Application Publication
(10) Pub. No.: US 2013/0096980 A1
(43) Pub. Date: Apr. 18, 2013

(54) USER-DEFINED COUNTERMEASURES

(71) Applicants: Prasanna Ganapathi Basavapatna, Bangalore (IN); Deepakeshwaran Kolingivadi, San Jose, CA (US); Sven Schrecker, San Marcos, CA (US)

(72) Inventors: Prasanna Ganapathi Basavapatna, Bangalore (IN); Deepakeshwaran Kolingivadi, San Jose, CA (US); Sven Schrecker, San Marcos, CA (US)

(73) Assignee: McAfee, Inc.

(21) Appl. No.: 13/334,206

(22) Filed: Dec. 22, 2011

Related U.S. Application Data
(60) Provisional application No. 61/548,226, filed on Oct. 18, 2011.

(51) Int. Cl. G06Q 10/00

(52) U.S. Cl. 705/7.28

(57) ABSTRACT

A particular set of computing assets is identified on a particular computing system including a plurality of computing assets. A user definition is received of a particular countermeasure applied to the particular set of assets, the user definition of the countermeasure including identification of each asset in the particular set of assets and identification of at least one vulnerability or threat addressed by the particular countermeasure in a plurality of known vulnerabilities or threats. Based on the user definition, actual deployment of the particular countermeasure on the particular computing system is assumed in a risk assessment of at least a portion of the particular computing system.

This patent application claims the benefit of priority under 35 U.S.C. §120 of U.S. Provisional Patent Application Ser. No. 61/548,226, filed Oct. 18, 2011, entitled “USER-DEFINED COUNTERMEASURES”, which is expressly incorporated herein by reference in its entirety.

### TECHNICAL FIELD

This disclosure relates in general to the field of computer security and, more particularly, to computer system risk assessment.

### BACKGROUND

The Internet has enabled interconnection of different computer networks all over the world. The ability to effectively protect and maintain stable computers and systems, however, presents a significant obstacle for component manufacturers, system designers, and network operators. Indeed, each day thousands of new threats, vulnerabilities, and malware are identified that have the potential of damaging and compromising the security of computer systems throughout the world. Maintaining security for large computing systems including multiple devices, components, programs, and networks can be daunting given the wide and evolving variety of vulnerabilities and threats facing the various components of the system. While security tools, safeguards, and other countermeasures may be available to counteract system threats and vulnerabilities, in some cases, administrators may be forced to triage their systems to determine how best to apply their financial, technical, and human resources to addressing such vulnerabilities. Risk assessment tools have been developed that permit users to survey risk associated with various devices and components in a system. A risk assessment of a system can identify and quantify the risk exposed to any one of a variety of system components as well as the overall risk exposed to the system as a whole.

### BRIEF DESCRIPTION OF THE DRAWINGS

FIG. 1 is a simplified schematic diagram of an example system including a risk assessment server in accordance with one embodiment;

FIG. 2 is a simplified block diagram of an example system including an example risk assessment engine in accordance with one embodiment;

FIG. 3 is a simplified block diagram representing an example risk assessment of a computing system in accordance with one embodiment;

FIGS. 4A-4B illustrates example scenarios involving a risk assessment of a system including user-defined countermeasures in accordance with at least some embodiments;

FIGS. 5A-5C illustrate screenshots of example user interfaces for use in connection with the definition of user-defined countermeasures in accordance with at least some embodiments;

FIG. 6 is a simplified flowchart illustrating example operations associated with at least some embodiments of the system.

Like reference numbers and designations in the various drawings indicate like elements.

### DETAILED DESCRIPTION OF EXAMPLE EMBODIMENTS

### Overview

In general, one aspect of the subject matter described in this specification can be embodied in methods that include the actions of identifying a particular set of computing assets on a particular computing system including a plurality of computing assets. A user definition can be received of a particular countermeasure applied to the particular set of assets, the user definition of the countermeasure including identification of each asset in the particular set of assets and identification of at least one vulnerability or threat addressed by the particular countermeasure in a plurality of known vulnerabilities or threats. Based on the user definition, actual deployment of the particular countermeasure on the particular computing system can be assumed in a risk assessment of at least a portion of the particular computing system.

In another general aspect of the subject matter described in this specification can be embodied in systems that include at least one processor device, at least one memory element, and a risk assessment engine. The risk assessment engine, when executed by the at least one processor device, can identify a particular set of computing assets on a particular computing system including a plurality of computing assets, receive a user definition of a particular countermeasure applied to the particular set of assets, and assume actual deployment of the particular countermeasure on the particular computing system in a risk assessment of at least a portion of the particular computing system. The user definition of the countermeasure can include identification of each asset in the particular set of assets and identification of at least one vulnerability or threat addressed by the particular countermeasure in a plurality of known vulnerabilities or threats.

These and other embodiments can each optionally include one or more of the following features. Risk assessment can include consideration of risk introduced by a set of vulnerabilities on the particular set of computing assets, the set of vulnerabilities included in the plurality of known vulnerabilities and including the at least one vulnerability, and consideration of a set of countermeasures applied to the particular set of computing assets, the set of countermeasures reducing the risk introduced by the set of vulnerabilities, and the set of countermeasures including at least one countermeasure other than the particular countermeasure. At least the particular set of computing assets can be scanned to identify at least one other countermeasure deployed on the particular set of computing assets. The particular countermeasure may not be detected in the scan of the particular set of computing assets. At least one other countermeasure can be identified from a plurality of known countermeasures, and the particular countermeasure may not be included in the plurality of known countermeasures. At least the particular set of computing assets can be scanned to identify the set of vulnerabilities. Identifying each vulnerability in the set of vulnerabilities can include identifying corresponding software assets affected by the respective vulnerability. The at least one vulnerability addressed by the particular countermeasure can be included in the set of vulnerabilities and the particular user-defined countermeasure can be considered in the risk assessment to reduce risk associated with the at least one vulnerability addressed by the particular countermeasure. A primary source of residual risk can be determined in the absence of the particular countermeasure. The determination of the primary source of residual risk can be revised based on the user definition of the particular countermeasure.

Further, these and other embodiments can also each optionally include one or more of the following features. The risk assessment can be made in connection with a modeling of the particular computing system, the modeling including hypothetical application of the particular countermeasure to the particular set of computing assets in the particular computer system. A hypothetical change in system risk can be identified resulting from application of the particular countermeasure to the particular set of computing assets. The user definition of the particular countermeasure can further include information for use in identifying the particular countermeasure on the particular computing system during subsequent scans of the computing system for deployed countermeasures. The particular system can be scanned to identify at least one other deployment of the particular countermeasure on an asset outside of the particular set of assets based on the user definition of the particular countermeasure. The user definition of the particular countermeasure can further include a degree to which the particular countermeasure mitigates risk associated with the at least one vulnerability, the degree being considered in the risk assessment. The degree can indicate that the particular countermeasure addresses the at least one vulnerability, but does not fully mitigate risk associated with the at least one vulnerability. At least one threat can be identified corresponding to the at least one vulnerability addressed by the particular countermeasure, resulting in the assumption that the at least one threat is mitigated by virtue of the particular countermeasure. The user definition of the particular countermeasure includes definition of at least one declaration rule for the particular countermeasure. The at least one declaration rule can include a plurality of declaration rules and the user definition of the particular countermeasure can define at least one of the plurality of declaration rules as at least temporarily disabled.

Some or all of the features may be computer-implemented methods or further included in respective systems or other devices for performing this described functionality. The details of these and other features, aspects, and implementations of the present disclosure are set forth in the accompanying drawings and the description below. Other features, objects, and advantages of the disclosure will be apparent from the description and drawings, and from the claims.

### EXAMPLE EMBODIMENTS

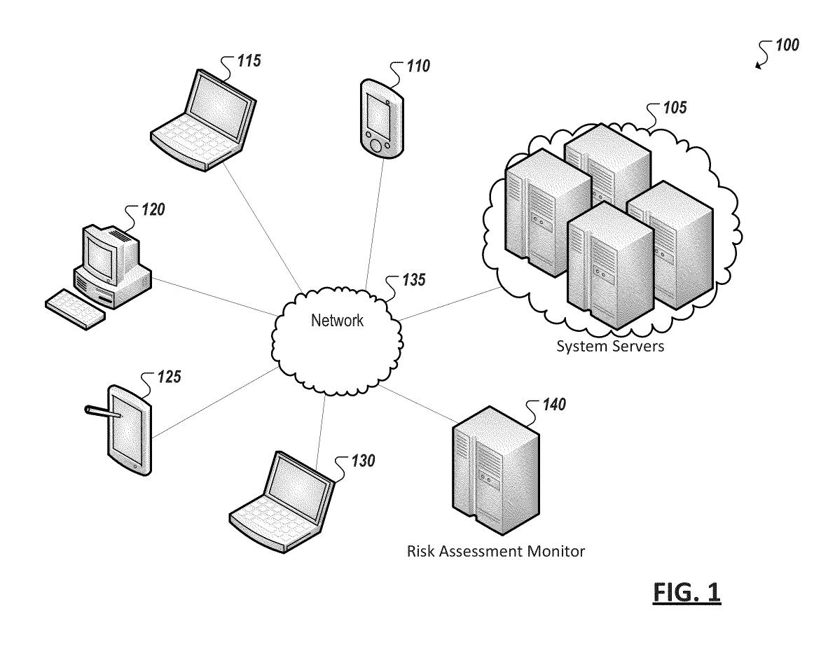

FIG. 1 is a simplified block diagram illustrating an example embodiment of a computing system 100 including one or more system servers 105 providing backend and mainframe support for the system, as well as serving applications, shared resources, programs, and other services and resources used within the system, for instance, by other system servers 105 including application servers, as well as end user devices 110, 115, 120, 125, 130. End user devices 110, 115, 120, 125, 130 can include computing devices operable to communicate with other devices in the system 100, for instance, over one or more networks 135, in connection with system users consuming, developing, testing, or otherwise interacting with programs, applications, services, and other functionality of the system 100 (e.g., provided by system servers 105). Further, a risk assessment server 140 can be provided in system 100 adapted to screen and analyze devices, applications, network elements, storage elements, and other components and resources (collectively “assets”) in system 100 to assess computing risk associated with individual system assets, as well as the composite or aggregate risk in subsystems including two or more of the system's assets, as well as the system 100 itself.

In general, “servers,” “devices,” “computing devices,” “end user devices,” “clients,” “endpoints,” “computers,” and “system assets” (e.g., 105, 110, 115, 120, 125, 130, 140) can include electronic computing devices operable to receive, transmit, process, store, or manage data and information associated with the software system 100. As used in this document, the term “computer,” “computing device,” “processor,” or “processing device” is intended to encompass any suitable processing device adapted to perform computing tasks consistent with the execution of computer-readable instructions. Further, any, all, or some of the computing devices may be adapted to execute any operating system, including Linux, UNIX, Windows Server, etc., as well as virtual machines adapted to virtualize execution of a particular operating system, including customized and proprietary operating systems.

Servers, computing devices, and other system assets (e.g., 105, 110, 115, 120, 125, 130, 140) can each include one or more processors, computer-readable memory, and one or more interfaces. System servers 105 (as well as end user devices 110, 115, 120, 125, 130) can include any suitable software component or module, or computing device(s) capable of hosting and/or serving software applications and other programs, including distributed, enterprise, or cloud-based software applications. For instance, application servers can be configured to host, serve, or otherwise manage web services or applications, including SOA-based services, modular services and applications, cloud-based services, multi-component enterprise software services, and applications interfacing, coordinating with, or dependent on other enterprise services, including security-focused applications. In some instances, some combination of servers can be hosted on a common computing system, server, or server pool, and share computing resources, including shared memory, processors, and interfaces, such as in an enterprise software system serving services to a plurality of distinct clients.

System assets can include end user devices 110, 115, 120, 125, 130 in system 100. End user devices 110, 115, 120, 125, 130 can include devices implemented as one or more local and/or remote client or endpoint devices, such as personal computers, laptops, smartphones, tablet computers, personal digital assistants, media clients, web-enabled televisions, telepresence systems, and other devices adapted to receive, view, compose, send, or otherwise interact with, access, manipulate, consume, or otherwise use applications, programs, and services served or provided through system servers 105. A client or end user device 110, 115, 120, 125, 130 can include any computing device operable to connect or communicate at least with servers 105, other client or end user devices, network 135, and/or other devices using a wireline or wireless connection. Each end user device can include at least one graphical display device and user interfaces, allowing a user to view and interact with graphical user interfaces of applications, tools, services, and other software of system 100. In general, end user devices can include any electronic computing device operable to receive, transmit, process, and store any appropriate data associated with the software environment of FIG. 1. It will be understood that there may be any number of end user devices associated with system 100, as well as any number of end user devices external to system 100. Further, the term “client,” “end user device,” “endpoint device,” and “user” may be used interchangeably as appropriate without departing from the scope of this disclosure. Moreover, while each end user device may be described in terms of being used by one user, this disclosure contemplates that many users may use one computer or that one user may use multiple computers.

While FIG. 1 is described as containing or being associated with a plurality of elements, not all elements illustrated within system 100 of FIG. 1 may be utilized in each alternative implementation of the present disclosure. Additionally, one or more of the elements described herein may be located external to system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Risk assessment server 140 can perform risk assessments of the system 100 and individual assets within or otherwise using the system 100. Traditional risk assessments attempt to identify all of the vulnerabilities and/or threats present on or facing a particular system asset and calculate computing risk associated with these vulnerabilities and threats. A risk assessment can further identify countermeasures deployed or otherwise implemented on the system that serve to mitigate against the risk posed by particular vulnerabilities and/or threats.

Each asset (e.g., 105, 110, 115, 120, 125, 130, 140) can have one or more vulnerabilities and thereby be vulnerable to one or more threats. Threats can include, for example, worms, viruses, malware, and other software or agents that cause unauthorized attacks. Each asset can be protected by a variety of countermeasures. These countermeasures include passive countermeasures and active countermeasures. Passive countermeasures can be provided by agent-based sensors and/or network-based sensors. Such “sensors” can include software adapted to monitor the assets themselves and/or network traffic to and from the assets. For illustrative purposes, the sensors are described as both monitoring the assets and protecting the assets by providing one or more countermeasures. However, the monitoring and countermeasure functionalities do not have to be provided by the same sensor (or device hosting the sensors). In the description below, sensor is used to refer to various types of monitoring and protection systems including, for example, firewalls, host intrusion prevention systems, network intrusion prevention systems, network access control systems, intrusion detection systems, intrusion prevention systems, anti-virus software, and spam filters.

Sensors can include one or more passive countermeasures that are part of the sensor. These passive countermeasures can include software programs and/or hardware that protect assets from various threats. Each passive countermeasure reduces the risk that a threat will affect an asset. A passive countermeasure protects against a threat by attempting to detect and stop an attack associated with the threat, by detecting and stopping activities associated with the attack, or by mitigating damage caused by an attack. For example, a passive countermeasure may be configured to detect data having a signature associated with a particular attack, and block data with that signature. As another example, a passive countermeasure may generate back-up copies of particular files targeted by an attack, so that even if the attack attacks the files, the files can be restored. Example passive countermeasures include, but are not limited to, hardware firewalls, software firewalls, data loss prevention systems, web proxies, mail filters, host-based intrusion prevention systems, network-based intrusion prevention systems, rate-based intrusion prevention systems, content-based intrusion prevention systems, intrusion detection systems, and virus detection software.

Passive countermeasures can also be partial countermeasures that do not completely protect from or mitigate the effects of an attack. For example, a partial passive countermeasure might block some, but not all, of the network traffic associated with a particular attack. As another example, if a threat needs either direct physical access or network access to compromise an asset, an example partial passive countermeasure would block network access to the asset, but not physical access.

Agent-based sensors can include software-based sensors that are installed on respective assets (e.g., 105, 110, 115, 120, 125, 130, 140). In some examples, instances of an agent-based sensor can be installed or otherwise loaded independently on each of a plurality of system assets. An agent-based sensor can be adapted to run various analyses on their respective assets, for example, to identify vulnerabilities on the assets or to identify viruses or other malware executing on the assets. Such agent-based sensors can include general- or multi-purpose sensors adapted to identify multiple different types of vulnerabilities or threats on an asset, as well as specialized sensors adapted to identify particular vulnerabilities and threats on an asset. Agent-based sensors may also provide one or more passive countermeasures for threats, as described above. As but one example, an agent-based sensor can include antivirus software loaded on an asset.

Network-based sensors can include hardware devices and/or software in a data communication path (e.g., in network 135) between system assets monitored and/or protected by the sensor and the network resources that the asset is attempting to access. In some implementations, a single network-based sensor can be in a communication path with each asset, while in other configurations multiple network-based sensors can be connected to the same asset, and some assets may not be connected to any network-based sensors.

When an asset (e.g., 105, 110, 115, 120, 125, 130, 140) tries to send information through the network 135 or receive information over the network 135, for instance, through a network-based sensor, the sensor analyzes information about the asset and the information being sent or received and determines whether to allow the communication. An example network-based sensor includes one or more processors, a memory subsystem, and an input/output subsystem. The one or more processors can be programmed according to instructions stored in the memory subsystem, and monitor the network traffic passing through the input/output subsystem. The one or more processors are programmed to take one or more protective actions on their own, or to query a sensor control system and take further actions as instructed by the sensor control system. Example network-based sensors include network access control systems, firewalls, routers, switches, bridges, hubs, web proxies, application proxies, gateways, network access control systems, mail filters, virtual private networks, intrusion prevention systems and intrusion detection systems.

The assets 104 can also be protected by one or more active countermeasures that are applied to the asset. Active countermeasures can make changes to the configuration of assets or the configuration of existing passive countermeasures to actively eliminate a vulnerability. In contrast, passive countermeasures hide the effects of a vulnerability, but do not remove the vulnerability. Each active countermeasure eliminates, or at least reduces, the risk that a threat will affect an asset when the active countermeasure is applied to the asset by eliminating, or at least reducing, a vulnerability. An active countermeasure protects against a threat by modifying the configuration of an asset (e.g., 105, 110, 115, 120, 125, 130, 140) so that the asset is no longer vulnerable to the threat. For example, an active countermeasure can close a back door that was open on an asset or correct another type of system vulnerability. Example active countermeasures include, but are not limited to, software patches that are applied to assets.

The assets (e.g., 105, 110, 115, 120, 125, 130, 140) may be vulnerable to many different threats at any given time. Some of the assets 104 may be already protected by one or more countermeasures, and some of the assets may need to have additional countermeasures put in place to protect the assets from the threats. Therefore, it is helpful to determine a risk metric for each asset and each threat (and/or vulnerability). The risk metric is a quantitative measure of the risk that a threat or vulnerability poses to an asset, both in terms of the probability that the threat or vulnerability will affect the asset and the magnitude of the potential effect. Risk metrics can be calculated, for instance, through the assistance of one or more risk assessment monitors 140 processing data about potential threats on the system and its network(s), as well as countermeasures provided by the sensors and vulnerabilities of the assets, in order to generate risk metrics for assets and threats. The risk assessment monitors 140 can also develop counter-risk metrics quantifying the effect of countermeasures identified within the system 100. Further, risk assessment monitors 140 can aggregate risk metrics across the system to develop composite risk profiles or scores of the system and subsystems thereof.

Among the deficiencies of some existing risk assessment tools is that risk assessment tools can be limited in their ability to identify and consider all of the vulnerabilities, threats, and countermeasures facing a system. For example, typical risk assessment tools, including sensors, may scan a system, its assets, data flows, and resources for files, headers, device identifiers, registers, and other data to identify threats, vulnerabilities, and countermeasures that match the profiles of threats, vulnerabilities, and countermeasures known to the risk assessment system. However, threats, vulnerabilities, and countermeasures that are not known or expected by a particular risk assessment tool may be overlooked, thereby resulting in inaccurate risk assessments of the system. For examples, proprietary or custom, and newly developed or modified countermeasures may not be known or included in databases of a particular traditional risk assessments tool and would be ignored in risk assessments of systems, devices, and components that make use of the unidentified countermeasures to mitigate against risks from corresponding vulnerabilities.

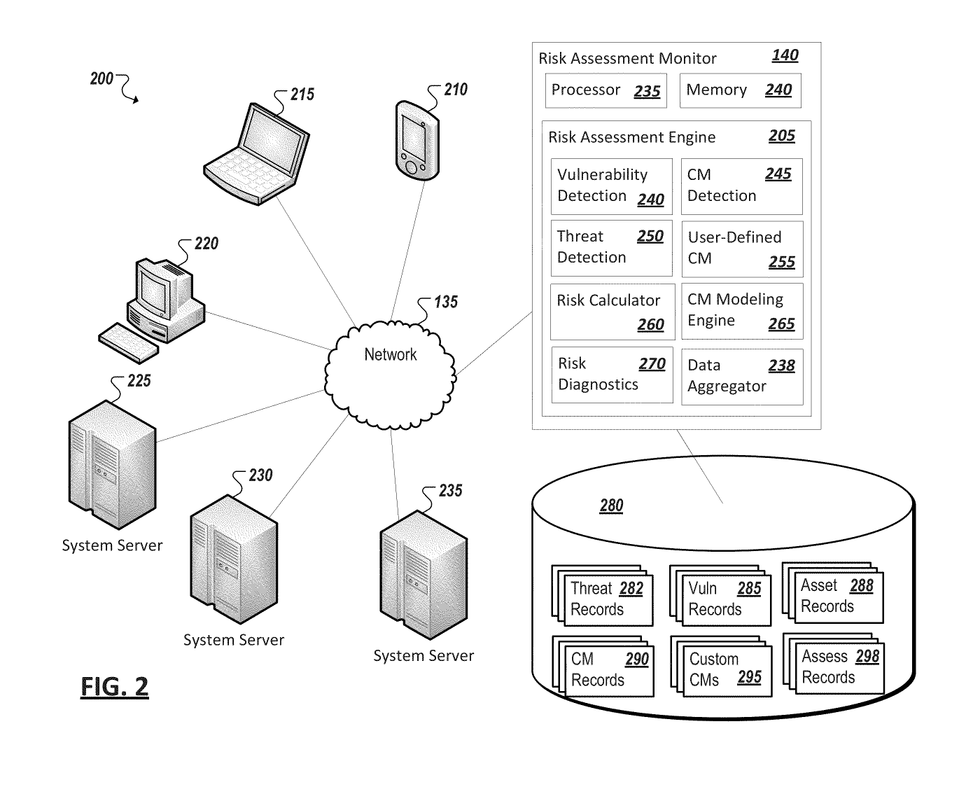

Computing system 100, in some implementations, can resolve many of the issues identified herein relating to traditional risk assessments of computing systems and their component assets. For instance, in the example diagram 200 illustrated in FIG. 2, a risk assessment monitor 140 is shown including an example risk assessment engine 205. The risk assessment engine 205 can be used to perform various tasks relating to assessment of risk at each of a plurality of system assets, including client or end user devices 210, 215, 220 and backend and enterprise system devices and servers 225, 230, 235. Further, risk assessment engine 205 can include components allowing users to custom-define and identify countermeasures not otherwise known or automatically detectable in connection with a risk assessments of the system.

An example risk assessment engine 205 can include a variety of functions and features, provided, for instance, through one or more software-based modules. As an example, an example risk assessment engine 205 can include a vulnerability detection engine 240, countermeasure detection engine 245, and threat detection engine 250 for use in automatically identifying vulnerabilities, deployed countermeasures, and threats affecting particular assets (e.g., 210, 215, 220, 225, 230, 235) in system 100. Further a user-defined countermeasure engine 255 can be provided for use in allowing users to supplement findings of countermeasure detection engine 245 and provide a more complete picture of the countermeasures deployed on one or more system assets.

Using vulnerabilities (e.g., detected or identified using vulnerability detection engine 240), countermeasures (e.g., detected or identified using countermeasure detection engine 245 and user-defined countermeasure engine 255), and threats (e.g., detected or identified using threat detection engine 250) a variety of risk-based analyses can be completed. For instance, a risk calculator 260 can be used to complete a risk assessment of one or more corresponding system assets, for instance, by calculating one or more risk scores or risk profiles for the assets. Further, a countermeasure modeling engine 265 can be used to model hypothetical risk in assets and systems employing hypothetical or planned countermeasures, as well as the effect of such hypothetical countermeasures on system risk. Additionally, risk diagnostics engine 270 can provide analyses of risk assessments of various system assets and be used to identify assets, system areas, categories, or subsystems posing or contributing disproportionately to residual risk present in a particular system. Analyses carried out by a risk diagnostics engine 270 can be used, for instance, to assist administrators and other IT personnel in identifying areas in a system that remain the most vulnerable after deployment of a most-recent set of countermeasures, that would be the best candidates for additional countermeasures, or that are exposed to the most risk, and so on. Risk diagnostics engine 270 can also be used to analyze and identify the success and effect of countermeasures on the system, including identification of those countermeasures that have the greatest, most economical, or most consistent impact on risk in a system, subsystem, or particular asset.

Risk assessment monitor 140 can receive (and store in one or more data stores 280) one or more of threat definition data 282, vulnerability detection data 285, asset configuration data 288, and countermeasure detection data 290. The threat definition data 282 can describe identified threats, what countermeasures (if any) protect assets from the threats and vulnerabilities, and the severity of the threat. The vulnerability detection data 285 can specify, for each asset and for each threat, whether the asset is vulnerable to the threat, not vulnerable to the threat, how the asset is vulnerable to one or more known or unknown threats, and/or of unknown vulnerability. The asset configuration data 288 can specify, for each asset (e.g., 210, 215, 220, 225, 230, 235), details of the configuration of the asset. The countermeasure detection data 290 can specify, for each asset, what countermeasures are protecting the asset.

Asset configuration data 288 can be received from one or more configuration data sources, including one or more data aggregators (e.g., 238). A data aggregator 238 can be one or more servers that receive configuration data, aggregate the data, and format the data in a format useable by the risk assessment monitor 140. Data aggregators 238 can receive configuration data from the assets themselves or from the sensors monitoring the assets. For example, a data aggregator 238 can maintain an asset data repository with details on asset configurations. Further, configuration data sources can include the assets themselves (e.g., 210, 215, 220, 225, 230, 235) and/or sensors monitoring the assets. In instances where configuration data is received from the assets and/or sensors directly, the configuration data may not be aggregated when it is received, and can be aggregated, for instance, by the risk assessment monitor 140 itself.

The configuration of an asset can be a hardware and/or software configuration. Depending on the configuration, various threats may be applicable to an asset. In general, the configuration of the asset can include one or more of the physical configuration of the asset, the software running on the asset, and the configuration of the software running on the asset. Examples of configurations include particular families of operating systems (e.g., Windows™, Linux™, Apple OS™, Apple iOS™), specific versions of operating systems (e.g., Windows™), particular network port settings (e.g., network port 8 is open), and particular software products executing on the system (e.g., a particular word processor, enterprise application or service, a particular web server, etc.). In some implementations, the configuration data does not include or directly identify countermeasures in place for the asset, or whether the asset is vulnerable to a particular threat.

Threat definition data 282 can be received from a threat detection engine 250. A threat detection engine 250 can identify threats and countermeasures that protect against the threats. In some implementations, the threat detection engine 250 can provide a threat feed with the threat definition data for the risk assessment monitor 140. A threat feed can include, for example, threat definition data sent over the network either as needed, or according to a predefined schedule.

Threat definition data 282 can identify one or more threats. Threat definition data 282 can further specify one or more threat vectors for each threat. Each threat vector can represent a vulnerability exploited by the threat and how the vulnerability is exploited, e.g., representing a particular attack associated with the threat. In some implementations, multiple threat vectors for a threat are aggregated into a single threat vector representing the entire threat. In other implementations, the individual threat vectors for a threat are separately maintained. As used herein, threat means either an attack represented by a single threat vector, or an overall threat represented by one or more threat vectors.

Threat definition data 282 further specifies, for each threat, the countermeasures that protect against the threat and a protection score for each countermeasure. In general, the protection score estimates the effect that the countermeasure has on mitigating the threat. The protection score for each countermeasure has a value in a predetermined range. Values at one end of the range (e.g., the low end) indicate that the countermeasure provides a low level of mitigation. Values at the other end of the range (e.g., the high end) indicate that the countermeasure provides a high level of mitigation. For instance, an example protection score can range from zero to one-hundred: a countermeasure having a protection score of zero for a threat when the countermeasure does not cover the threat (e.g., the threat is out of the scope of the countermeasure, the coverage of the countermeasure is pending, the coverage of the countermeasure is undermined by something else executing on the asset, when coverage is not warranted, or when the coverage of the countermeasure is under analysis), a protection score of 100 when the countermeasure is expected to, or actually does, provide full coverage from the threat, and protection scores somewhere between 0 and 100 when some, but less than all coverage from the threat is provided by the countermeasure. Other scales, and other discretizations of the protection score can alternatively be used.

Threat definition data 282 can also includes applicability data for each threat. Applicability data can specify asset configurations make an asset vulnerable to the threat. For example, the applicability data can specify that the threat only attacks particular operating systems or particular software products installed on an asset, or that the threat only attacks particular versions of products, or products configured in a particular way. Threat definition data 282 can also include a severity score for the threat. The severity score can be an estimate of how severe an attack by the threat would be for an asset, and may optionally also estimate how likely the threat is to affect assets. The severity score can be calculated according to multiple factors including, for example, a measure of how a vulnerability is exploited by a threat; the complexity of an attack once the threat has gained access to the target system; a measure of the number of authentication challenges typically determined during an attack by a threat; an impact on confidentiality of a successfully exploited vulnerability targeted by the threat; the impact to the integrity of a system of a successfully exploited vulnerability targeted by the threat; and the impact to availability of a successfully exploited vulnerability targeted by the threat. The severity score can be specified by a third party or determined by the information source, such as the vendor, manufacturer, or manager of risk assessment monitor 140 or one of its component modules.

In some implementations, threat definition data 282 can also specify which sensors and/or which software products executing on the sensors can detect an attack corresponding to the threat. For example, suppose threat A can attack all machines on a network with a specific vulnerability and that product B can detect the vulnerability when it has setting C. Furthermore, product D provides passive countermeasures that mitigate the effect of the threat. In this case, the threat definition data can specify that threat A attacks all machines, that product B with setting C can detect the vulnerability to the threat, and that product D provides passive countermeasures that protect against the threat.

The threat definition data 282 can also optionally include other details for the threat, for example, whether the existence of the threat has been made public, who made the existence of the threat public (e.g., was it the vendor of the software that has been compromised?), a web address for a public disclosure of the threat, and one or more attack vectors for the threat. The attack vectors can be used to determine what passive countermeasures are protecting the asset from the threat at a given time. Threat definition data 282 may also include other information about the threat, for example, a brief description of the threat, a name of the threat, an estimate of the importance of the threat, an identifier of the vendor(s) whose products are attacked by the threat, and recommendations on how to mitigate the effects of the threat.

In some implementations, threat definition data 282 has a hierarchical structure (e.g., multiple tiers). For example, the first tier can include a general identification of the products that are vulnerable to the threat such as the name of a software vendor or the name of a particular product vulnerable to the threat. Additional tiers can include additional details on needed configurations of the assets or other details of the threat, for example, particular product versions or settings including the applicability data described above.

The vulnerability detection data 285 can be detected and/or received from one or more vulnerability detection engines 240. In some implementations, vulnerability detection engine 240 can aggregate vulnerability detection data from individual sensors and assets in the system. The individual sensors can be agent-based sensors and/or network-based sensors. Vulnerability detection data 285 for a given asset can specify, for instance, what tests and scans were run by sensors protecting the asset, as well as the outcome of those tests and scans. Example tests include virus scans, vulnerability analyses, system configuration checks, policy compliance checks, network traffic checks (e.g., provided by a firewall, a network intrusion detection system, or a network intrusion prevention system), and tests performed by host-based intrusion prevention systems or host-based intrusion detection systems. The vulnerability detection data 285 allows the risk assessment monitor 140 to determine, in some cases, that an asset has one or more vulnerabilities that can be exploited by a threat, and to determine, in other cases, that the asset does not have any vulnerabilities that can be exploited by the threat. Some threats exploit only a single vulnerability, while other threats exploit multiple vulnerabilities.

Multiple sensors may test for the same vulnerability. In that case, the vulnerability detection data 285 can include the outcome of all of the tests for the vulnerability (optionally normalized, as described below). Alternatively, the vulnerability detection data 285 may include the outcome for only a single test, for example, a test that found the asset vulnerable or a test that found the asset not vulnerable. In some instances, vulnerabilities on an asset may be determined to have been neutralized or stopped by a particular countermeasure, such as an active countermeasure, implemented on the asset.

Countermeasure detection data 290 can be detected and/or received using countermeasure detection engine 245. In general, countermeasure detection data 290 specifies, for a given asset, what countermeasures are in place to protect the asset. In some implementations, countermeasure detection data 290 can also specify what known countermeasures are available or installed but not protecting the asset. A countermeasure is not protecting an asset, for example, when it is not in place at all, or when it is in place to protect the asset but is not properly configured.

A countermeasure detection engine 245 can collect, detect, and maintain the settings of individual sensors in the system, as well as data specifying which assets are protected by which sensors. For example, the countermeasure detection engine 245 can be one or more computers that receive data about the protection provided by sensors in the network and data about which sensors protect which assets. Such data can be aggregated to determine which countermeasures are in place to protect each asset. Example settings can include an identification of the product providing the countermeasure, a product version, and product settings corresponding to a detected countermeasure. Other example settings include one or more signatures of threats (e.g., file signatures or network traffic signatures) that are blocked by the countermeasure.

Countermeasures can be provided by network-based sensors in the system's network, agent-based sensors in the system or both. When a countermeasure is provided by an agent-based sensor running on the asset, it can be determined that the countermeasure is protecting the asset. However, network-based countermeasures are remote from the assets they are protecting. Therefore, additional data may be needed to associate network-based passive countermeasures with the assets they protect. Countermeasure detection engine 245 can determine and maintain records of which assets are monitored by which sensors, and then associate, for each sensor, the countermeasures provided by the sensor with each of the assets monitored by the sensor. Countermeasure detection engine 245, in some instances, can automatically detect associations between countermeasures and the assets they protect. For instance, countermeasure detection engine 245 can automatically correlate sensors with assets based on alerts received from the sensors. Each alert can identify an attack on an asset that was detected by the sensor. For example, when a sensor detects an attack on a particular IP address, the countermeasure source(s) 214 can determine that the sensor is protecting an asset with that particular IP address. In some implementations, the data associating sensors with assets can associate a sub-part of the sensor with the asset, when that sub-part protects the asset. For example, if a particular port on a network-based sensor, or a particular software program running on a sensor, protects an asset, the association can further specify the port or software program.

In addition to countermeasure detection data 290 at least partially recognized, detected, and associated with threats, vulnerabilities, and assets known to the system (e.g., through risk assessment monitor 140), user-defined countermeasure data 295 can be generated and used, for instance, using user-defined countermeasure engine 255. Custom, proprietary, in-development, one-off, and other countermeasures can exist within a system that are not recognized by, detectable by (e.g., using countermeasure detection engine 245), or otherwise known to a system. For instance, a custom or third-party countermeasure can be employed on a system for which countermeasure detection data 290 is undetectable, or otherwise unavailable to risk assessment monitor 140.

User-defined countermeasure engine 255 can provide user interfaces for use by users to self-identify and -define particular countermeasures on an asset or system. In some instances, a user can be become aware of the unknown nature of a countermeasure or its attributes based on a query of existing countermeasure detection data 290, thereby motivating the use to define one or more custom countermeasure records 295 for the unknown countermeasure. A custom countermeasure record 295 generated for a user-defined countermeasure can include information identifying the user-defined countermeasure, describing its implementation or deployment, associating particular assets with the user-defined countermeasure (i.e., that are protected using the user-defined countermeasure), as well as the identification of vulnerabilities and/or threats that the countermeasure counteracts, including information defining the degree to which the user-defined countermeasure counteracts or protects against an associated vulnerability or threat.

Custom countermeasure records 295 generated by user-defined countermeasure engine 255 describing user-defined countermeasures, can be used together with threat definition data 282, vulnerability detection data 285, asset configuration data 288, and countermeasure detection data 290 in connection with risk assessments and other analyses of assets and subsystems of a system, as well as the system itself. As user-defined countermeasures can potentially be as effective at counteracting risk associated with various threats and/or vulnerabilities as other known countermeasures on the system, considering the effect of user-defined countermeasures can result in more accurate and robust analyses of the system.

As an example, a risk score can be calculated, for instance, using risk calculator 260 for a particular asset, subsystem, or system that makes use of one or more user-defined countermeasures. Further, administrators can use user-defined countermeasures to model the effect of hypothetical countermeasures within a system, for instance, in connection with countermeasure modeling engine 265. Further, risk diagnostics engine 270 can perform additional analyses of system assets and subsystems characterizing how risk affect a particular system and how countermeasures affect or could potentially affect risk within the system. Assessments, including risk scores, countermeasure modeling, and risk diagnostics, generated using risk assessment engine 205 can be recorded in assessment records stored in data store 280. Assessment records 298 can, in turn, be accessed by other tools, including risk calculator 260, countermeasure modeling engine 265, and risk diagnostics engine 270, and used in subsequent modeling and diagnostic assessments.

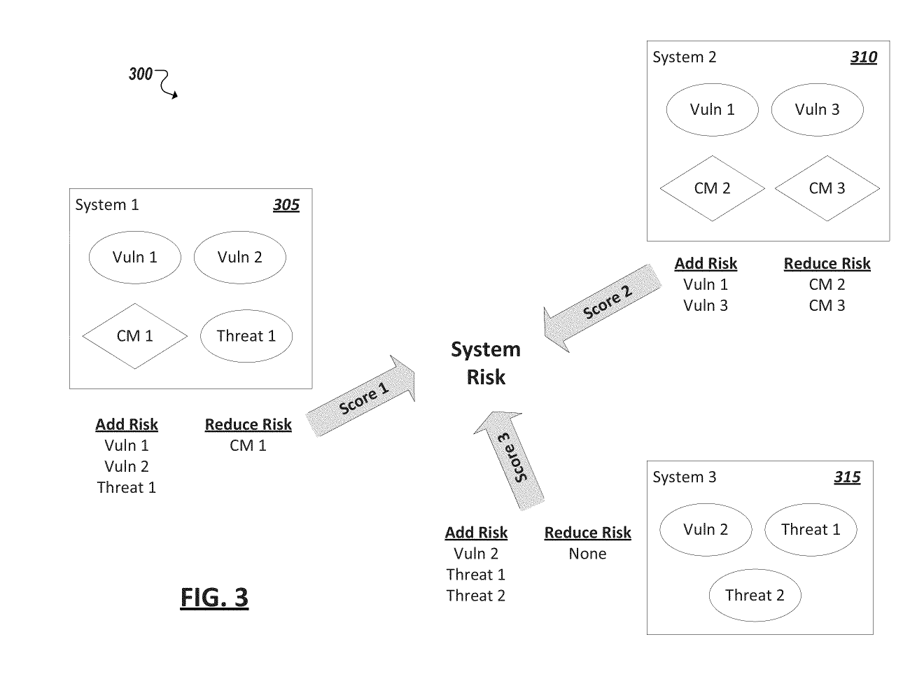

Turning to FIG. 3, example risk score assessments are illustrated in the representation of block diagram 300. Three assets 305, 310, 315 are shown, each with identified, associated vulnerabilities, threats, and/or countermeasures. For instance, it can be identified, for instance, in connection with scanning of asset 305 (e.g., by one or more sensors or security tools) that vulnerabilities “Vuln 1” and “Vuln 2” are present on the asset 305 and that the asset 305 is exposed to a threat “Threat 1.” Further, a countermeasure “CM 1” can be identified on the asset 305. Generally, vulnerabilities (e.g., “Vuln 1” and “Vuln 2”) and threats (e.g., “Threat 1”) can add to a risk score (e.g., “Score 1”) generated for a particular asset 305 (i.e., evidencing higher risk associated with the asset 305), while countermeasures tend to reduce the risk score of the asset. A variety of formulas and algorithms can be employed to determine a risk score, risk profile, or otherwise assess risk of an individual system asset. In some implementations, calculation of a risk score (e.g., “Score 1,” “Score 2,” “Score 3”) can receive as inputs and consider such data as a severity score of an identified threat and/or vulnerability, a likelihood of damage due to an identified vulnerability or threat, a degree to which a countermeasure mitigates against vulnerabilities or threats, a predicted effectiveness of a countermeasure, how configuration data for asset enhances the risk from identified vulnerabilities and threat, how configuration data for the asset enhances the effectiveness of a particular countermeasure, among other examples.

In some implementations, an aggregate or composite risk score or assessment can be performed by aggregating risk assessment results for assets comprising a particular subsystem or the system itself. For instance, as shown in the simplified illustrative example of FIG. 3, risk scores (e.g., “Score 1,” “Score 2,” and “Score 3”) can be generated for a plurality of assets 305, 310, 315 based on the respective assets' associated configuration data, vulnerabilities, threats, and countermeasures. Further, one of a variety of formulas or algorithms can be applied to aggregate or otherwise consider the composite risk associated with assets 305, 310, 315 operating in a single system or subsystem. For instance, in some examples, a system or aggregate risk score can be aggregated, normalized, or averaged from the component risk scores of the involved assets (e.g., 305, 310, 315), without considering interdependencies of the various assets and corresponding risk profiles. In other instances, an aggregate risk assessment can also consider the extent, if any, to which interactions between and inclusion of a particular set of assets within a particular system or subsystem enhances or diminishes the risk of the individual assets.

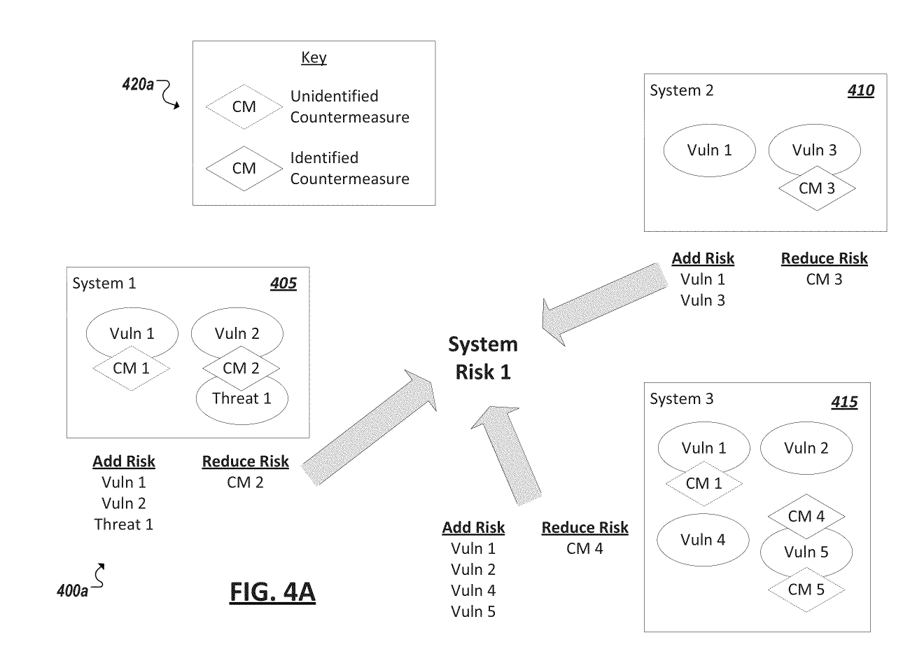

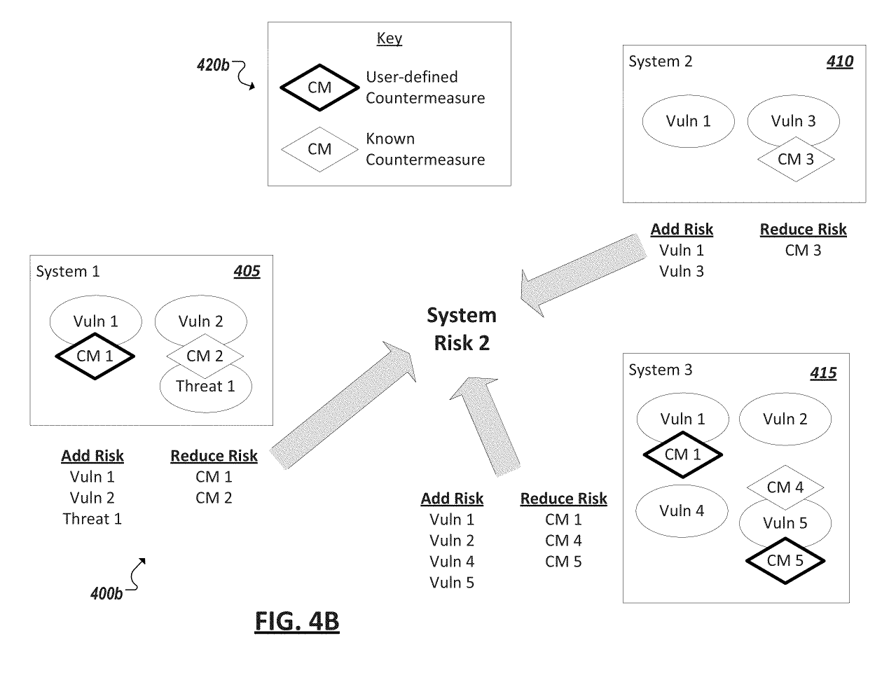

Turning to FIGS. 4A-B, additional example risk score assessments are illustrated in the representations of block diagrams 400a-b. For instance, assets can include, be associated with, or be otherwise protected by one or more countermeasures, including active and passive countermeasures, countermeasures implemented local to the asset, as well as countermeasures implemented remote from the asset. While represented, in FIGS. 4A-4B as contained within assets 405, 410, 415, it should be appreciated that the countermeasures (e.g., CM 1, 2, 3, 4, and 5) shown to be included within the representations of assets 405, 410, 415 merely indicate that the countermeasure is associated with or otherwise protects a corresponding asset, and does not necessarily indicate the type of the countermeasure or how it is implemented (e.g., whether the countermeasure is local to, provided by, or contained within the asset). For instance, any of countermeasures CM 1, 2, 3, 4, and 5 may be provided remote from the assets they protect, such as a countermeasure operating on a network to which the asset is connected and sends and receives data.

As indicated in FIG. 4A (at key 420a), some of the countermeasures (e.g., CM 2, CM 3, CM 4) may be countermeasures capable of being detected and inspected using one or more techniques or modules (e.g., countermeasure detection engine 245) to identify and collect countermeasure detection data 290 describing aspects of the countermeasures and their respective protection of one or more assets (e.g., 205, 210, 215) in a system. Further, other countermeasures (e.g., CM 1 and CM 5) can be deployed or provided that protect one or more assets (e.g., 205, 210, 215) or otherwise affect risk associated with particular assets. Such countermeasures (e.g., CM 1 and CM 5) may include countermeasures not fully recognized by or recognizable to countermeasure detection tools and scans used to identify countermeasures protecting assets in a system and attributes of the countermeasures relating to the countermeasures' protection of assets on the system.

As shown in the example of FIG. 4A, failure to properly identify and appreciate the function of all countermeasures in a system (e.g., by failing to consider unidentified countermeasures CM1 and CM 5) can result in incomplete or inaccurate risk assessments of assets in a system, as well as risk assessments of the system itself. For example, the risk associated with one or more vulnerabilities, such as vulnerability Vuln 1 affecting assets 405 and 415, may be at least partially mitigated by the actual, but unidentified, deployment of a particular countermeasure CM 1. Failure to identify countermeasure CM 1, for instance, may result in risk scores being generated for assets 405 and 415 that (incorrectly) assume that the assets 405, 415 are fully exposed to risk (as well as relevant threats) associated with the vulnerability Vuln 1. As a result, risk associated with assets 405 and 415 may be mistakenly believed to be higher than the actual risk associated with the assets 405, 415. Moreover, system administrators using the risk assessments may mistakenly conclude (e.g., if they know about the deployment of unidentified countermeasure CM 1) that one or more countermeasures meant to protect a given asset are operating ineffectively, and/or that one or more vulnerabilities are currently more risky than is the case (e.g., if the administrator is not familiar with the unidentified countermeasure CM 1, for instance, based on undue reliance of a risk assessment's detection and enumeration of countermeasures on the system).

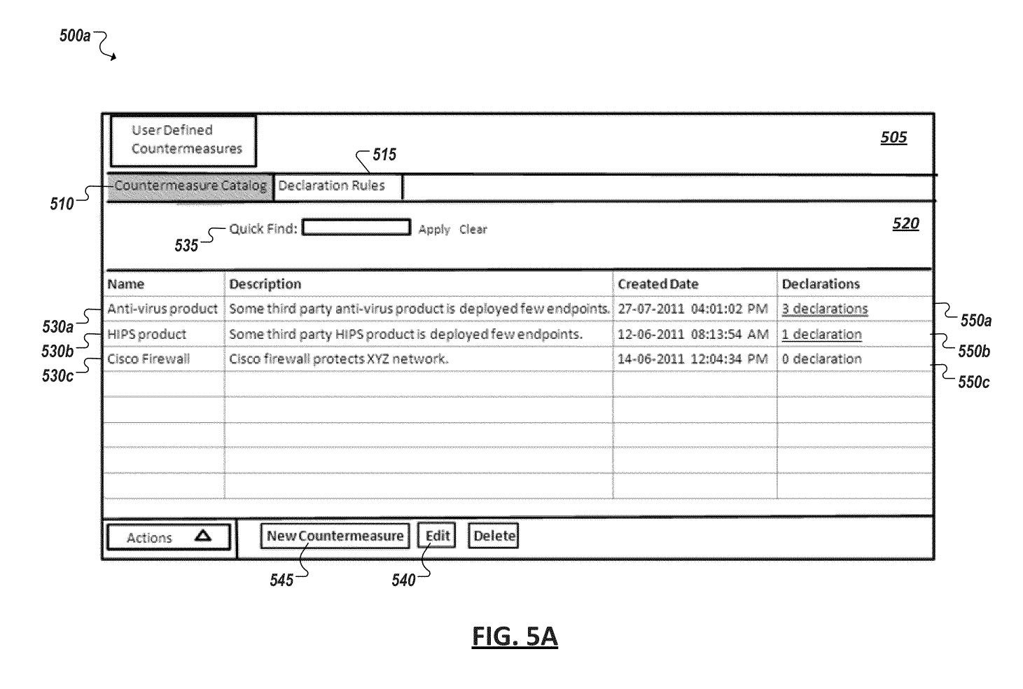

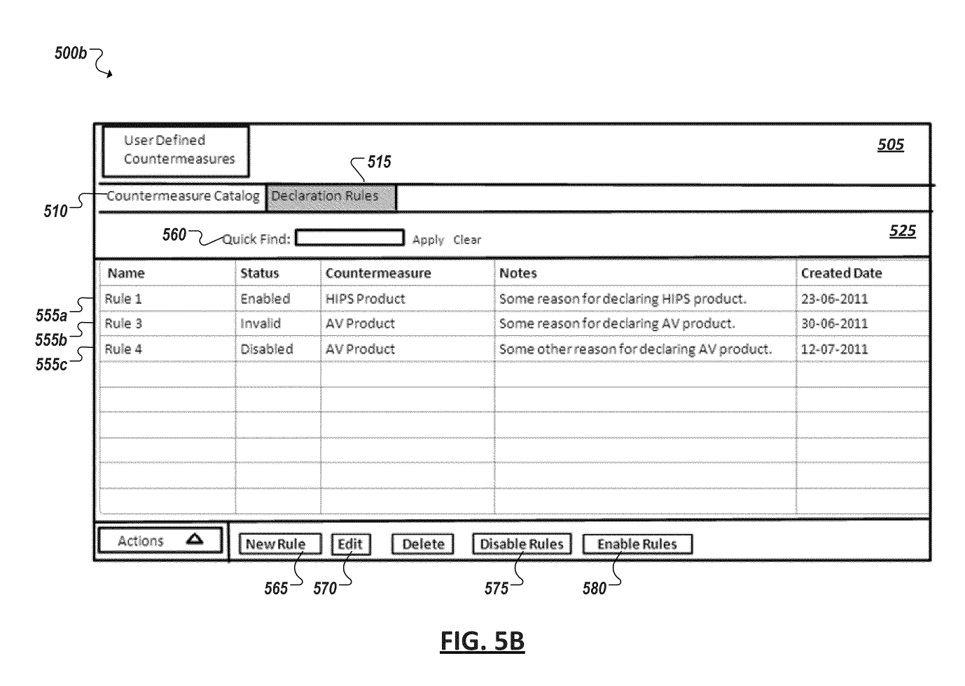

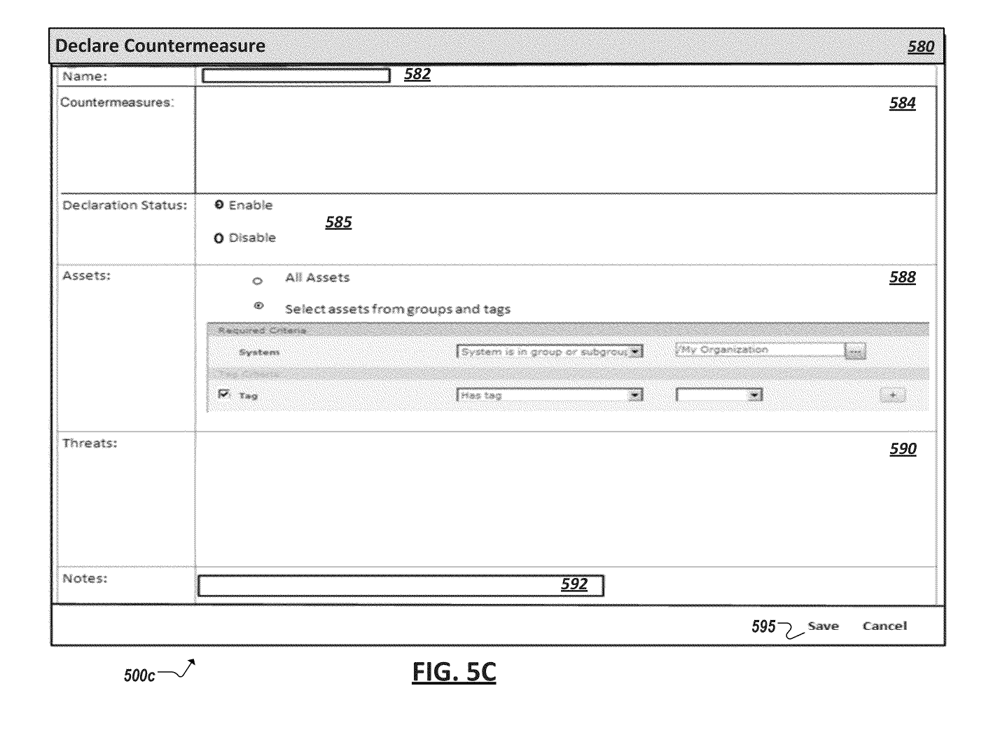

Turning to FIG. 4B, users can custom-define countermeasures deployed or otherwise used within a system but not otherwise identifiable to the system. For instance, users, such as system administrators, can utilize user interfaces (such as those shown in the examples of FIGS. 5A-5C described below) of a user-defined countermeasure engine (e.g., 255) to define, for risk assessment tools, attributes of countermeasures present on the system but not detected or detectable by the risk assessment tools. For example, an administrator, upon identifying that a particular deployed countermeasure CM 1 was not identified during a scan or risk assessment of the system, can manually identify the countermeasure and define attributes of the countermeasure, including the operation of the countermeasure, its applicability to vulnerabilities or threats known to the system, its protection of particular system assets, including types or groups of system assets, how it protects the assets from a particular threat or vulnerability, as well as the degree to which the countermeasure protects corresponding assets from the threat or vulnerability. For instance, in the example of FIG. 4B, a user has defined countermeasure CM 1 as protecting assets 405, 415 from a vulnerability Vuln 1. Additionally, declaration rules can be defined by a user that indicate how and to what extent the countermeasure CM 1 protects assets 405, 415 from vulnerability Vuln 1.

Risk can be assessed, by one or more risk assessment tools using one or more risk assessment formulas, to consider user-defined countermeasures (e.g., CM 1, CM 5) along with other deployed countermeasures automatically detected by the risk assessment tools and other sensors and detection tools. Indeed, using the user definitions for the user-defined countermeasures, user-defined countermeasures can be assessed the same as any other countermeasure automatically identified within the system. While a risk assessment tool may have more familiarity and a pre-existing understanding of some countermeasures (e.g., countermeasures that have been pre-identified and are automatically detectable by the risk assessment tools and sensors) as well as the attributes, rules, and functions of such detectable countermeasures, the risk assessment tool can defer to the user's own definition for unidentified (but now user-defined) countermeasures and assess risk for the system based on the assumption that the user has provided an accurate characterization of the user-defined countermeasure's existence, deployment, operation, and effectiveness. Accordingly, risk assessments incorporating user-defined countermeasures can consider the extent to which the user-defined countermeasures negate the risk associated with vulnerabilities and threats addressed by the user-defined countermeasures (e.g., based on rules and attributes defined for the user-defined countermeasures explaining how and under what conditions the user-defined countermeasure block a particular threat or overcome a particular vulnerability for one or more assets). Consequently, in the example of FIG. 4B, the composite system risk (i.e., “System Risk 2”) calculated for assets 405, 410, 415, including user-defined countermeasures CM 1 and CM 5, may be lower than the composite system risk (i.e., “System Risk 1”) determined for the assets 405, 410, 415 where countermeasures CM 1 and CM 5 remained unidentified.

Users can also identify attributes of user-defined countermeasures that allow at least some portion of the user-defined countermeasure's existence or operation to be subsequently automatically-detected by a risk assessment tool. The risk assessment tool may still lack the ability to independently detect a user-defined risk assessment tool, its attributes, and functions, but a user can define some identifying information for use by the user-defined risk assessment tool to predict the additional inclusion or protection of such tools for other assets in the system. For instance, a user can define, in the user-definition of the countermeasure, a file name, IP or MAC address, data flow packet header content, data flow formats or protocols, among other information that can be associated with the user-defined countermeasure. Without a user associating such identification information with the user-defined countermeasure, a risk assessment tool and sensors monitoring network connections and assets in connection with the risk assessment tool may be unable or incapable of accounting for the source or significance of files, network elements, resources, and data flows relating to the user-defined countermeasure. Based on such associations, however, risk assessment tools and coordinating sensors may be able to identify associated data, files, devices, or resources discovered within the system as relating to a particular user-defined countermeasure based on representations and associations made by a user in the definition of the user-defined countermeasure.

In addition to generating risk assessment profiles and scores for assets and systems by incorporating the effects of user-defined countermeasures on risk within the system, other risk-based diagnostics can also consider user-defined countermeasures. For instance, based on risk assessments of a system, criticality analyses can be run to identify particular assets (e.g., individual assets, types of assets, grouping of assets, etc.), particular users of assets (e.g., individual users, groups of users, etc. associated with particular assets), and particular threats and vulnerabilities that are contributing to or are associated with assets that are contributing disproportionately to the overall risk, or residual risk, experienced by a system. Residual risk indicates the net amount of risk remaining in a system in light of the deployment of particular countermeasures reducing overall risk in a system. Accordingly, assets, vulnerabilities, and threats with higher criticality can be regarded as good candidates for future or improved countermeasure deployments, as high criticality assets, vulnerabilities, and threats are ostensibly being inadequately addressed by existing countermeasures. Further, failing to properly identify particular countermeasures deployed on a system can result in the mistaken determination that assets, vulnerabilities, and threats addressed by such unidentified countermeasures are of high criticality, diverting attention from other assets, vulnerabilities, and threats that are not adequately addressed by deployed countermeasures. For example, by considering a user-defined countermeasure protecting against a particular vulnerability previously determined to have a high criticality within the system, calculation of the overall residual risk in the system can be lowered together with the criticality of the particular vulnerability addressed by the user-defined countermeasure. Further, given the effect of the user-defined countermeasure on the system's residual risk and the criticality of related assets, vulnerabilities, and threats, the criticality of other less-protected assets or less-mitigated vulnerabilities and countermeasure can be determined to be higher relative to others in a system, highlighting a need for administrators to address these other assets, vulnerabilities, and threats over those protected by the user-defined countermeasure.

In some instances, the functionality and tools used to user-define particular unidentified countermeasures can be used to monitor hypothetical countermeasure deployments in a system. In some aspects, a risk assessment or diagnostic tool may consider user-defined countermeasures without any independent corroboration or guarantee that the user-defined countermeasure is actually deployed or includes the functionality a user has defined it to possess. Accordingly, a user can, in some instances, create a hypothetical user-defined countermeasure and allow risk assessment and diagnostic tools to consider the effect of the hypothetical user-defined countermeasure within the system. Indeed, through the creation of one or more hypothetical user-defined countermeasure (i.e., countermeasures that are not actually deployed on a system), a user can model the effect and value of developing, acquiring, purchasing, or otherwise deploying such countermeasures on a system, in terms of the effects such countermeasures would have on risk within an asset or system of assets.

Turning to FIGS. 5A-5C, screenshots 500a-c are shown illustrating example user interfaces adapted for use, in some example implementations, in the creation and editing of user-defined countermeasures for inclusion in risk assessments of a system. For example, FIG. 5A illustrates a screenshot 500a of a user interface 505 of a user-defined countermeasure catalog identifying and presenting one or more previously-created user-defined countermeasures to a user, for instance, in connection with an effort by a user to edit an existing user-defined countermeasure or create a new user-defined countermeasure. User-defined countermeasure user interface 505 can include tabs 510, 515 allowing a user to toggle between two or more window views, in this example, windows corresponding to a countermeasure catalog listing window 520 and a window corresponding to user-defined countermeasure declaration rules (e.g., window 525 of FIG. 5B). In example catalog listing window 520, a listing of user-defined countermeasures (e.g., 530a-c) can be presented to a user. In some instances, the listing of user-defined countermeasures can include a subset of user-defined countermeasures 530a-c defined in a system. The subset of user-defined countermeasures included in the displayed catalog listing window 520 can be based, for example, on a filtering or a search of the user-defined countermeasures in the system, such as a search query entered by a user through a search engine interface element 535.

A user can select one or more user-defined countermeasures included in catalog window 520 to inspect attributes and other details of the selected user-defined countermeasure. For instance, a user can identify, view details of, and even edit declaration rules (e.g., 550a-c) associated with particular user-defined countermeasures. For instance, selection of hyperlink 550a would display the three declaration rules of user-defined anti-virus product 530a. Further, a user can edit attributes (such as a countermeasure's declaration rules) of one or more preexisting user-defined countermeasures, for instance, by selecting Edit button 540. Additionally, a user can create or define a new user-defined countermeasure, for instance, by selecting New Countermeasure button 545.

Turning to FIG. 5B, user interface 505 is shown presenting declaration rules window 525. Declaration rules window 525 can present declaration rules that have been created in connection with the definition of user-defined countermeasures in a system. Declaration rules can identify assets that are protected by a countermeasure, vulnerabilities and/or threats that are mitigated by a countermeasure, as well as rules that identify what aspects of a vulnerability or threat are counteracted using the countermeasure, together with the conditions under which the countermeasure is effective or declared. The declaration rules (e.g., 555a-c) presented in declaration rules window 525 can include a subset of rules defined using a user-defined countermeasure engine, including declaration rules of a particular countermeasure or category of countermeasures, or a subset of declaration rules returned in response to a search or filtering of the entire of set of declaration rules within a system (e.g., using search tool 560). Declaration rules within a system can be pre-generated declaration rules, including declaration rules relating to known countermeasures detectable by a risk assessment tool. Declaration rules can further include custom, user-generated declaration rules. For instance, user can define new declaration rules, for instance, by selecting New Rule button 565, as well as edit pre-existing declaration rules (and create new declaration rules by editing pre-existing declaration rules), for instance by selecting Edit button 570.

Declaration rules can be enabled (e.g., using button 580), disabled (e.g., using button 575), or invalidated. Enabled rules can be considered live rules that a live deployment of a user-defined countermeasure is employing as the basis of the user-defined countermeasure's operation within the system. Disabled declaration rules are rules that indicate additional functionality of a deployed user-defined countermeasure that are not currently employed by or relevant to the user-defined countermeasure's current deployment within the system. Further, in some implementations, while a system or risk assessment tool may defer to the representations of a user-defined countermeasure's capabilities as defined by a particular user, the system, a risk assessment system, or user-defined countermeasure engine can perform some quality control functions on user-defined countermeasures. For instance, quality control scans can be completed on defined declaration rules for user-defined countermeasures to identify errors in the declaration rules, such as invalid references to assets in the system, vulnerabilities, and threats as well as erroneous attributes of measures that user-defined countermeasures could take to address a particular vulnerability or threat (such as a countermeasure action that claims to protect against a network-element-based vulnerability by performing unrelated tasks on, for instance, an end-user device). Detection of errors or inconsistencies in a declaration rule can result in the declaration rule being declared “invalid.”

FIG. 5C is a screenshot of an example user interface 580 provided to assist users in defining or editing declaration rules for user-defined countermeasures, for instance, in response to the selection of New Rule button 565 or Edit button 570 in user interface 505 shown in the example of FIG. 5B. User interface 580 can include multiple fields and interface elements (e.g., 582, 584, 585, 588, 590, 589, 595) accepting inputs of a user. For instance, a user can define a name for the new declaration rule (using interface element 582) and specify one or more countermeasures whose functionality depends on the declaration rule (e.g., using interface element 584). The declaration rule can be initially enabled or disabled (e.g., using radio elements 585) and particular assets can be identified that are protected by the rule (e.g., using interface element 588). Particular assets affected by the declaration rule can be selected, for instance, using drop down or explorer-type user interface elements. Additionally, groupings of assets can be selected, such as assets belonging to a particular category or grouping of assets, or according to one or more taxonomies, or tagging, of the assets. For instance, assets can be manually- or automatically-associated with one or more taxonomy tags, and assets can be grouped according to these tags. For instance, a user may attempt to create a new declaration rule for a newly-defined user-defined countermeasure that affects assets of a particular type, such as network routers. Accordingly, a user can attempt to find and apply the new declaration rule to all network routers in a system by applying the rule to all assets tagged as “Routers,” among many other examples.

Protection against certain threats (and/or vulnerabilities) can also be identified (e.g., using interface element 590), allowing the user to associate a particular rule with one or more different vulnerabilities and threats (including vulnerabilities and threats that are interrelated). Additional interface elements and corresponding functions can be included in user interface 580, such as a notes field that allows a user to provide a short description summarizing the substance of the user-defined declaration rule. Further, fields and interface elements can be provided that permit a user to define, with finer granularity, how a particular rule relates to or affects a particular asset, vulnerability, or threat, for instance by defining how and under what conditions a related user-defined countermeasure is declared to protect an asset against elements of a vulnerability or threat. For instance, as an illustrative example, one or more declaration rules can be defined for a user-defined firewall deployed on a system but not identified by a risk assessment tool. Such declaration rules might address a threat relating to the accessing of social networking sites on end user computing assets that include a particularly vulnerable Internet browser. For instance, one or more declaration rules can be defined for the user-defined firewall that include identification of the known social networking vulnerability, the affected end user devices, as well as rules indicating that the firewall will only control data received from websites with particular URLs corresponding to particular known social networking sites (i.e., leaving open the possibility that the assets may still be exposed to the social-networking-related-vulnerability from social networks not included in the set of sites known to the user-defined firewall). Additionally, in some instances, users can also provide data indicating the extent or degree to which a particular user-defined countermeasure (or declaration rule) protects corresponding assets against particular threats (or vulnerabilities).

Finally, upon completing the definition or editing of user-defined declaration rule (for one or more user-defined countermeasures), the declaration rule can be saved and made available for inspection and editing (e.g., in declaration rule window 520) in connection with the definition of one or more user-defined countermeasure. Further, declaration rules can be reused, for instance, in subsequent definitions of other user-defined countermeasures. Such defined user-defined countermeasures can then be assessed, based at least in part on the defined, enabled declaration rules associated with the countermeasure, in connection with one or more risk assessments of an asset or system protected by the user defined countermeasure.

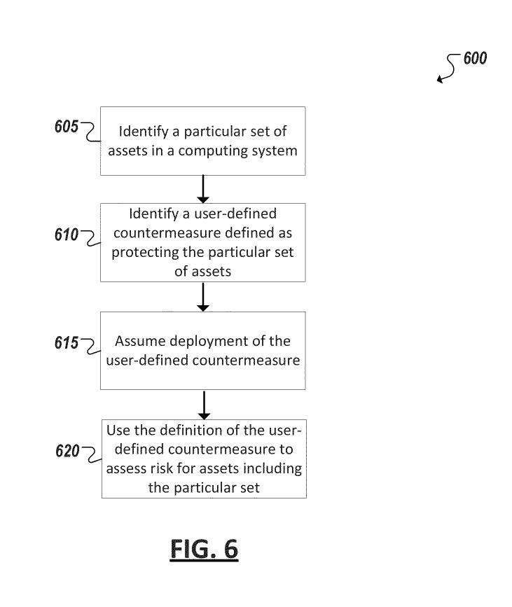

FIG. 6 is a simplified flowchart 600 illustrating example techniques for generating and using user-defined countermeasures in a risk assessment of one or more computing assets. For instance, a particular set of computing assets can be identified on a particular computing system including a plurality of computing assets. The particular set of computing assets can include one, two or more, or all assets in a system. A user definition of a particular countermeasure can be identified 610 defining a user-defined countermeasure that is identified as protecting at least the particular set of computing assets. The user definition of the countermeasure can include identification of each asset in the particular set of assets and identification of at least one vulnerability and/or at least one threat addressed by the user-defined countermeasure. The user-defined countermeasure can be a countermeasure deployed on the system to protect at least the particular set of assets that is unidentified or undetected by one or more risk assessment tools used to audit and catalog the countermeasures deployed on the system for use in determining one or more measurements of risk for the system and its composite assets. Accordingly, actual deployment of the user-defined countermeasure can be assumed 615, based on the user definition of the user-defined countermeasure, and accepted by the one or more risk assessments tools as possessing the features and attributes defined in the user definition of the user-defined countermeasure. Further, in some implementations, the one or more risk assessment tools can use 620 the user definition of the countermeasure to assess risk for a system, asset, or group of assets that include deployment of the user-defined countermeasure.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal per se, a computer storage medium can be a source or destination of computer program instructions encoded in an artificially generated propagated signal. The computer storage medium can also be, or be included in, one or more separate physical components or media (e.g., multiple CDs, disks, or other storage devices), including a distributed software environment or cloud computing environment.

The operations described in this specification can be implemented as operations performed by a data processing apparatus on data stored on one or more computer-readable storage devices or received from other sources. The terms “data processing apparatus,” “processor,” “processing device,” and “computing device” can encompass all kinds of apparatus, devices, and machines for processing data, including by way of example a programmable processor, a computer, a system on a chip, or multiple ones, or combinations, of the foregoing. The apparatus can include general or special purpose logic circuitry, e.g., a central processing unit (CPU), a blade, an application specific integrated circuit (ASIC), or a field-programmable gate array (FPGA), among other suitable options. While some processors and computing devices have been described and/or illustrated as a single processor, multiple processors may be used according to the particular needs of the associated server. References to a single processor are meant to include multiple processors where applicable. Generally, the processor executes instructions and manipulates data to perform certain operations. An apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, module, (software) tools, (software) engines, or code) can be written in any form of programming language, including compiled or interpreted languages, declarative or procedural languages, and it can be deployed in any form, including as a standalone program or as a module, component, subroutine, object, or other unit suitable for use in a computing environment. For instance, a computer program may include computer-readable instructions, firmware, wired or programmed hardware, or any combination thereof on a tangible medium operable when executed to perform at least the processes and operations described herein. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Programs can be implemented as individual modules that implement the various features and functionality through various objects, methods, or other processes, or may instead include a number of sub-modules, third party services, components, libraries, and such, as appropriate. Conversely, the features and functionality of various components can be combined into single components as appropriate. In certain cases, programs and software systems may be implemented as a composite hosted application. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, applications may represent web-based applications accessed and executed via a network (e.g., through the Internet). Further, one or more processes associated with a particular hosted application or service may be stored, referenced, or executed remotely. For example, a portion of a particular hosted application or service may be a web service associated with the application that is remotely called, while another portion of the hosted application may be an interface object or agent bundled for processing at a remote client. Moreover, any or all of the hosted applications and software service may be a child or sub-module of another software module or enterprise application (not illustrated) without departing from the scope of this disclosure. Still further, portions of a hosted application can be executed by a user working directly at a server hosting the application, as well as remotely at a client.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), tablet computer, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device, including remote devices, that are used by the user.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include any internal or external network, networks, sub-network, or combination thereof operable to facilitate communications between various computing components in a system. A network may communicate, for example, Internet Protocol (IP) packets, Frame Relay frames, Asynchronous Transfer Mode (ATM) cells, voice, video, data, and other suitable information between network addresses. The network may also include one or more local area networks (LANs), radio access networks (RANs), metropolitan area networks (MANs), wide area networks (WANs), all or a portion of the Internet, peer-to-peer networks (e.g., ad hoc peer-to-peer networks), and/or any other communication system or systems at one or more locations.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A method comprising:
identifying a particular set of computing assets on a particular computing system including a plurality of computing assets;
receiving a user definition of a particular countermeasure applied to the particular set of assets, the user definition of the countermeasure including identification of each asset in the particular set of assets and identification of at least one vulnerability addressed by the particular countermeasure in a plurality of known vulnerabilities; and
assuming actual deployment of the particular countermeasure on the particular computing system in a risk assessment of at least a portion of the particular computing system.

2. The method of claim 1, wherein the risk assessment includes consideration of risk introduced by a set of vulnerabilities on the particular set of computing assets, the set of vulnerabilities included in the plurality of known vulnerabilities and including the at least one vulnerability, and consideration of a set of countermeasures applied to the particular set of computing assets, the set of countermeasures reducing the risk introduced by the set of vulnerabilities, and the set of countermeasures including at least one countermeasure other than the particular countermeasure.

3. The method of claim 2, further comprising scanning at least the particular set of computing assets to identify at least one other countermeasure deployed on the particular set of computing assets.

4. The method of claim 3, wherein the particular countermeasure is not detected in the scan of at least the particular set of computing assets.

5. The method of claim 4, wherein the at least one other countermeasure is identified from a plurality of known countermeasures, and the particular countermeasure is not included in the plurality of known countermeasures.

6. The method of claim 2, further comprising scanning at least the particular set of computing assets to identify the set of vulnerabilities.

7. The method of claim 6, wherein identifying each vulnerability in the set of vulnerabilities includes identifying corresponding software assets affected by the respective vulnerability.

8. The method of claim 2, wherein the at least one vulnerability addressed by the particular countermeasure is included in the set of vulnerabilities and the particular user-defined countermeasure is considered in the risk assessment to reduce risk associated with the at least one vulnerability addressed by the particular countermeasure.

9. The method of claim 1, further comprising:
determining a primary source of residual risk in the absence of the particular countermeasure; and
revising the determination of the primary source of residual risk based on the user definition of the particular countermeasure.

10. The method of claim 1, wherein the risk assessment is made in connection with a modeling of the particular computing system, the modeling including hypothetical application of the particular countermeasure to the particular set of computing assets in the particular computer system.

11. The method of claim 10, further comprising identifying a hypothetical change in system risk resulting from application of the particular countermeasure to the particular set of computing assets.

12. The method of claim 1, wherein the user definition of the particular countermeasure further includes information for use in identifying the particular countermeasure on the particular computing system during subsequent scans of the computing system for deployed countermeasures.

13. The method of claim 12, further comprising scanning the particular system to identify at least one other deployment of the particular countermeasure on an asset outside of the particular set of assets based on the user definition of the particular countermeasure.

14. The method of claim 1, wherein the user definition of the particular countermeasure further includes a degree to which the particular countermeasure mitigates risk associated with the at least one vulnerability, and the degree is considered in the risk assessment.

15. The method of claim 14, wherein the degree indicates that the particular countermeasure addresses the at least one vulnerability but does not fully mitigate risk associated with the at least one vulnerability.

16. The method of claim 1, further comprising:
identifying at least one threat corresponding to the at least one vulnerability addressed by the particular countermeasure; and
assuming that the at least one threat is mitigated by virtue of the particular countermeasure.

17. The method of claim 1, wherein the user definition of the particular countermeasure includes definition of at least one declaration rule for the particular countermeasure.

18. The method of claim 17, wherein the at least one declaration rule includes a plurality of declaration rules and the user definition of the particular countermeasure defines at least one of the plurality of declaration rules as at least temporarily disabled.

19. Logic encoded in non-transitory media that includes code for execution and when executed by a processor is operable to perform operations comprising:
identifying a plurality of computing assets on a particular computing system;
receiving a user definition of a particular countermeasure applied to a particular set of computing assets in the plurality of computing assets, the user definition of the countermeasure including identification of each asset in the particular set of assets and identification of at least one threat addressed by the countermeasure in a plurality of known threats; and
assuming actual deployment of the particular countermeasure on the particular computing system in a risk assessment of at least a portion of the particular computing system.

20. A system comprising:
at least one processor device;
at least one memory element; and
a risk assessment engine, adapted when executed by the at least one processor device to:
identify a particular set of computing assets on a particular computing system including a plurality of computing assets;
receive a user definition of a particular countermeasure applied to the particular set of assets, the user definition of the countermeasure including identification of each asset in the particular set of assets and identification of at least one vulnerability addressed by the particular countermeasure in a plurality of known vulnerabilities; and
assume actual deployment of the particular countermeasure on the particular computing system in a risk assessment of at least a portion of the particular computing system.

21. The system of claim 20, wherein the risk assessment engine is further adapted to calculate a score representing risk in the particular computing system, wherein calculating the score includes consideration of risk introduced by a set of vulnerabilities on the particular computing system, the set of vulnerabilities included in the plurality of known vulnerabilities and including the at least one vulnerability, and consideration of a set of countermeasures applied to the particular set of computing assets, the set of countermeasures reducing the risk introduced by the set of vulnerabilities, and the set of countermeasures including the particular countermeasure and at least one countermeasure other than the particular countermeasure, wherein consideration of the particular countermeasure is based on the user definition of the particular countermeasure.

22. The system of claim 20, further comprising a scanning engine, adapted when executed by the at least one processor device to detect countermeasures from a plurality of known countermeasures deployed on assets in the particular computing system.

23. The system of claim 22, wherein the scanning engine is unable to detect at least the particular countermeasure.
